(19) United States
(12) Patent Application Publication
(10) Pub. No.: US 2025/0085998 A1
(43) Pub. Date: Mar. 13, 2025

(54) CENTRALIZED ACCELERATION ABSTRACTION LAYER FOR RAN VIRTUALIZATION

(71) Applicant: NEC Laboratories Europe GmbH, Heidelberg (DE)

(72) Inventors: Andres GARCIA-SAAVEDRA, Heidelberg (DE); Xavier COSTA-PEREZ, Heidelberg (DE)

(21) Appl. No.: 18/727,354

(22) PCT Filed: Mar. 16, 2022
(86) PCT No.: PCT/EP2022/056834

§ 371 Date: Jul. 9, 2024

(30) Foreign Application Priority Data
Jan. 21, 2022 (EP) 22152728.6

(51) Int. Cl. G06F 9/455; G06F 9/50

(52) U.S. Cl. CPC G06F 9/45558; G06F 9/5083; G06F 2009/45595

(57) ABSTRACT

A method of coordinating allocation of radio processing operations associated with multiple vRAN nodes to shared computing resources is provided. The method includes receiving, by a centralized Acceleration Abstraction Layer (AAL) broker implemented on top of a shared accelerating computing infrastructure, an operation request from a virtual operation associated with a vRAN node, the operation request specifying an operation to be accelerated. The AAL broker selects, using a predefined or configurable scheduling policy, a physical hardware accelerator for accelerated execution of the operation. The AAL broker forwards the operation request to a processing queue of the selected hardware accelerator.

### CROSS REFERENCE TO RELATED APPLICATIONS

This application is a U.S. National Phase application under 35 U.S.C. § 371 of International Application No. PCT/EP2022/056834, filed on Mar. 16, 2022, and claims benefit to European Patent Application No. 22152728.6, filed on Jan. 21, 2022. The International Application was published in English on Jul. 27, 2023 as WO 2023/138799 A1 under PCT Article 21(2).

### FIELD

The present invention relates to a system and a method of coordinating allocation of radio processing operations associated with multiple vRAN nodes to shared computing resources.

### BACKGROUND

Extending network function virtualization (NFV) to the far edge of mobile networks would allow decoupling radio access network (RAN) workloads from the underlying hardware infrastructure in so-called vRANs. This approach has many advantages over heftier traditional RANs, e.g., mitigating vendor lock-in, streamlining upgrades, and multiplexing computing resources. Thus, RAN virtualization has become a key technology trend towards next-generation systems. Driven by the O-RAN Alliance, practically all the relevant players in the industry are deploying or building vRANs; and it is breeding a new market that brings unprecedented business opportunities to an ossified RAN ecosystem.

RANs comprise a number of base stations, each decomposed into a central unit (CU), processing the highest layers of the stack; a distributed unit (DU), processing lower layers including the radio link control, the MAC and the physical layer; and a radio unit (RU), performing basic radio functions such as signal sampling. In contrast to CUs, DUs may require computing infrastructure that processes signals in a timely and predictable manner. This is because the pipeline of tasks involved in the physical layer (PHY) has tight and hard timing constraints: missing deadlines may cause that users lose synchronization and network performance to collapse; and some of this tasks are compute-intensive. In this context, for illustration purpose, FIG. 1 shows the time that may be required by Intel© FlexRAN—which is software development kit (SDK) readily used by most solutions today to perform FEC (Forward Error Correction), rate matching, and CRC (Cyclic Redundancy Check) in general-purpose processors, for reference, see Intel. 2019. FlexRAN LTE and 5G NR FEC Software Development Kit Modules. https://software.intel.com/content/www/us/en/develop/articles/flexran-lte-and-5g-nr-fec-software-development-kit-modules.htm—to successfully decode 4-Kbyte transport blocks modulated with 64QAM, encoded with LDPC and 1/3 code rate, and for different signal-to-noise-ratio regimes between 10 dB and 30 dB, in a dedicated CPU core).

Consequently, vRAN solutions in the industry today resort to offloading compute-intensive operations, mostly FEC tasks such as LDPC encoding/decoding, into dedicated hardware accelerators (HAs). HAs are GPUs, FPGAs, ASICs, or even CPUs that are dedicated to one single task (e.g., FEC). Because they are programmable and can execute radio processing operations very fast, GPU acceleration (e.g., NVIDIA Aerial) and FPGA acceleration (e.g., Intel® FlexRAN, providing both FPGA drivers and CPU libraries (exploiting Intel AVX-512 instruction sets) for FEC acceleration) are the most popular processors.

However, as acknowledged by top executives in the business, the current approach is doomed to fail. The root cause is the strong dependency on HAs that are exclusive to individual DUs, which diminishes flexibility and renders higher cost and power consumption than the traditional ASIC-based DUs: the very reasons virtualization is considered for the RAN in the first place. This is particularly disappointing because HA resources are largely underutilized most of the time due to lack of opportunities for statistical multiplexing in short timescales.

A more sensible approach is to share accelerating resources with multiple DUs, using standard interfaces that provide suitable abstractions, to maximize resource utilization and hence minimize costs. O-RAN refers to this as Acceleration Abstraction Layer (AAL). Hardware accelerators (HAs) hold the key to preserving carrier-grade performance of network functions (NFs), including radio signal processing functions such as DUs, without compromising the flexibility provided by virtualization. HAs may be a set of CPUs dedicated to one single task, more specialized processors such as GPUs, functions implemented on field-programmable gate arrays (FPGAs), or fixed-functions implemented on application-specific integrated circuits (ASICs) that can execute one task faster than a shared general-purpose processor (GPP) made of CPUs, as illustrated in FIG. 2.

In this context, Ding, Jian, et al. “Agora: Real-time massive MIMO baseband processing in software.” Proceedings of the 16th International Conference on emerging Networking EXperiments and Technologies. 2020, disclose a 5G signal processor built on top of FlexRAN's open libraries that is suitable for many-core general-purpose CPUs, that is, without requiring additional HAs. However, their solution is not suitable for shared platforms, and the amount of CPU cores that may be required to provide carrier-grade performance with a single vDU renders overly high costs and energy consumption.

More recently, Foukas, Xenofon, and Bozidar Radunovic. “Concordia: teaching the 5G vRAN to share compute.” Proceedings of the 2021 ACM SIGCOMM 2021 Conference. 2021, disclosed a system that comprises a task scheduler that allows a virtualized DU to share computing resources with other applications to maximize resource usage. However, the approach does not address the case of multiple DUs sharing a common pool of HAs.

Furthermore, G. Garcia-Aviles, A. Garcia-Saavedra, M. Gramaglia, X. Costa-Perez, P. Serrano, and A. Banchs. “Nuberu: Reliable RAN Virtualization in Shared Platforms”. MobiCom '21. Proceedings of the 27th Annual International Conference on Mobile Computing and Networking. October 2021. Pages 749-761. https://doi.org/10.1145/3447993.3483266, describe a DU design that provides reliability in non-deterministic (shared) computing platforms by relying on predictions and trading off latency for reliability. Though the use of DUs that are reliable in such environments is of paramount importance, the question of how to allocate computing resources efficiently across all DUs still remains.

### SUMMARY

In an embodiment, the present disclosure provides a method of coordinating allocation of radio processing operations associated with multiple vRAN nodes to shared computing resources. The method comprises: receiving, by a centralized Acceleration Abstraction Layer (AAL) broker implemented on top of a shared accelerating computing infrastructure, an operation request from a virtual operation associated with a vRAN node, the operation request specifying an operation to be accelerated; selecting, by the AAL broker using a predefined or configurable scheduling policy, a physical hardware accelerator for accelerated execution of the operation; and forwarding, by the AAL broker, the operation request to a processing queue of the selected physical hardware accelerator.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram showing the decoding time of one transport block in a dedicated CPU core using Intel® FlexRAN;

FIG. 2 is a schematic overview illustrating latency improvements when offloading compute-intensive tasks to hardware accelerators;

FIG. 3 is a schematic view illustrating the general concept of an O-RAN Acceleration Abstraction Layer (AAL) according to prior art;

FIG. 4 is a schematic view illustrating an O-RAN architecture according to prior art;

FIG. 5 is a schematic view illustrating an O-RAN Acceleration Abstraction Layer (AAL) enhanced with an AAL broker in accordance with an embodiment of the present invention;

FIG. 6 is a schematic view illustrating an extended O-RAN architecture with modified E2 and O3 interfaces in accordance with an embodiment of the present invention; and

FIG. 7 is a schematic view illustrating an implementation of an AAL broker policy in accordance with an embodiment of the present invention.

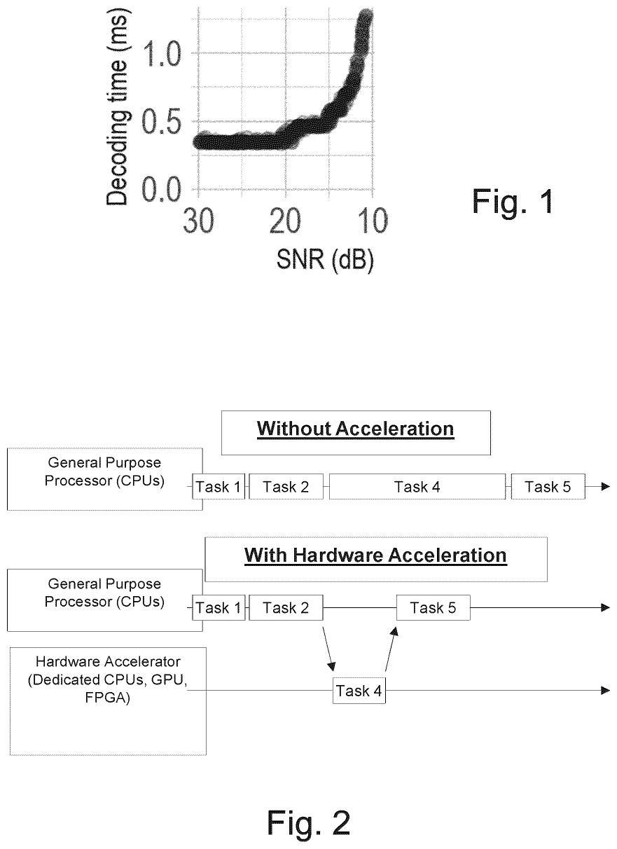

### DETAILED DESCRIPTION

In accordance with an embodiment, the present invention improves and further develops a method and a system of the initially described type for coordinating allocation of radio processing operations associated with multiple vRAN nodes to shared computing resources in such a way that the usage efficiency of the shared computing resources is improved.

In accordance another embodiment, the present invention provides a method of coordinating allocation of radio processing operations associated with multiple vRAN nodes to shared computing resources, the method comprising: receiving, by a centralized Acceleration Abstraction Layer, AAL, broker implemented on top of a shared accelerating computing infrastructure, an operation request from a virtual operation associated with a vRAN node, the operation request specifying an operation that shall be accelerated; selecting, by the AAL broker using a predefined or configurable scheduling policy, a physical hardware accelerator for accelerated execution of the requested operation; and forwarding, by the AAL broker, the operation request to a processing queue of the selected hardware accelerator.

According to another embodiment, the present invention implements a centralized Acceleration Abstraction Layer for RAN virtualization that operates on top of a shared accelerating computing infrastructure, e.g. the O-RAN AAL infrastructure. The proposed centralized Acceleration Abstraction Layer comprises a novel O-RAN entity, namely an AAL broker that provides a centralized approach to efficiently allocate a common and shared accelerating computing infrastructure (comprising pools of CPUs, GPUs, FPGAs, ASICs, etc.) to radio processing tasks associated with multiple vRAN nodes (e.g., vDUs). By means of supporting a centralized coordination of acceleration resources, the AAL broker enables an efficient implementation of load balancing, thereby avoiding overloading of individual ones of the available—heterogeneous—accelerating resources. As a result, the present invention provides a more cost-effective O-RAN solution by improving the usage efficiency of one of its most costly components (O-Cloud).

In an embodiment, the present invention relates to an O-RAN scenario where the abstraction layer coordinates all the vRAN requests to a pool of hardware accelerators. The AAL broker allows for a centralized approach to allocate a shared and joint accelerating resource i.e. pools of CPUs, GPUs, FPGAs, ASICs, etc. to radio processing tasks associated with multiple VDU (VRAN) nodes The AAL broker layer may receive the virtual operation requests (FEC, FFT, LDPC, etc.) and may find the appropriate queue to allocate the AAL device according to the requests. Further, the decoded bits of the respective function (FEC, FFT, LDPC etc.) may be fed back to the vRAN node through the broker layer.

With respect to a smooth and efficient operation it may be provided, in accordance with embodiments of the invention, that the AAL broker is implemented to interact with the underlying shared accelerating computing infrastructure as if it were an individual vRAN node. When implementing the system according to the present invention in the context of an O-RAN architecture, the underlying shared accelerating computing infrastructure the AAL broker interacts with may be the O-RAN AAL infrastructure, as described in detail, e.g., in O-RAN Alliance, “O-RAN Acceleration Abstraction Layer General Aspects and Principles (O-RAN.WG6.AAL-GAnP-v01.01)”, Technical Specification, July 2021.

According to an embodiment of the invention, the operation request of a vRAN node may include information about the operation that shall be accelerated (e.g., FEC, FFT, CRC), the data that may be required to execute the operation (e.g., code blocks in case of a FEC decoding operation), and settings to execute the operation (e.g., maximum number of decoding iterations in the case of FEC decoding operation).

According to an embodiment of the invention, the hardware accelerator selected by the AAL broker to execute the requested acceleration of a particular task/operation may be configured to perform the requested operation in a FIFO manner according to the requests in its associated processing queue. This assures a fair and seamless operation.

According to an embodiment of the invention, the AAL broker may be further configured to receive, directly or indirectly, responsive to forwarding the operation request to the processing queue of the selected hardware accelerator, a response from the selected hardware accelerator, and to forward the response received from the selected hardware accelerator to the issuing vRAN node.

According to an embodiment of the invention, the scheduling policy used by the AAL broker to select a physical hardware accelerator for accelerated execution of the requested operation may be implemented with a machine learning, ML, model minimizing a cost function that combines information about network throughput and energy consumption of the underlying shared accelerating computing infrastructure.

Embodiments of the present invention provide extension to O-RAN interfaces to jointly allocate shared computing resources to radio processing tasks and radio resources to mobile users in a centralized manner. Specifically, a new E2 end-point may be implemented that connects a resource controller with NFs such as O-DUs to deploy radio policies on NFs from O-Cloud. Additionally or alternatively, a new E2 end-point may be implemented that connects the resource controller with Near-RT RIC to update the information available therein about the state of NFs, which preserves consistency across the whole O-RAN system. Finally, a new O3 interface may be implemented to deploy computing polices on the AAL broker from the resource controller.

There are several ways how to design and further develop the teaching of the present invention in an advantageous way. To this end it is to be referred to the following explanation of preferred embodiments of the invention by way of example, illustrated by the drawings on the other hand. In connection with the explanation of the preferred embodiments of the invention by the aid of the drawings, generally preferred embodiments and further developments of the teaching will be explained.

Embodiments of the present invention are based on open Radio Access Networks (O-RAN) and their implementations through the O-RAN Alliance specifications. O-RAN provides a technical concept designed to improve interoperability in the RANs of mobile networks. By defining standards for open interfaces and by providing network elements abstracted from hardware, O-RAN creates radio access networks that are independent of proprietary technology.

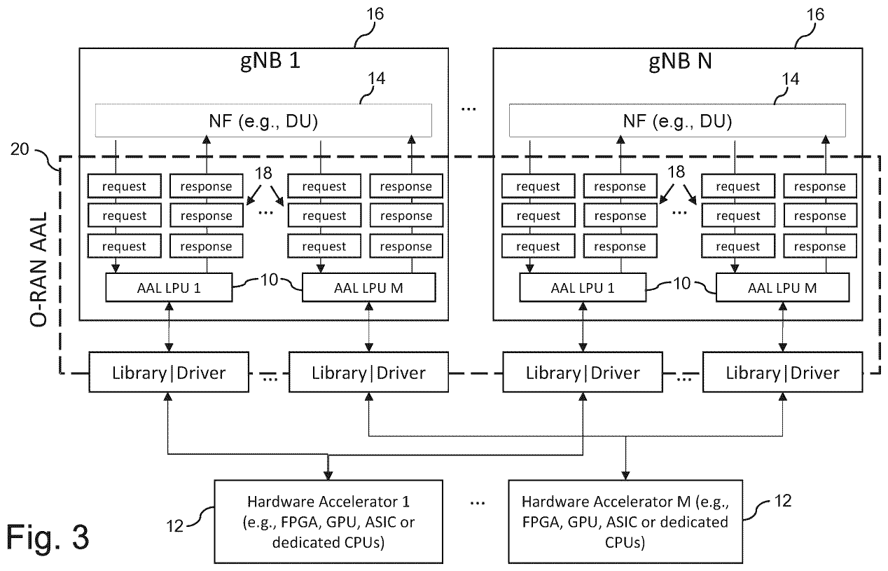

In this context, O-RAN's Acceleration Abstraction Layer (AAL) provides a common interface for Network Functions (NFs), such as Distributed Units (DUs) to access Hardware Accelerators (Has). This abstraction allows developers to decouple their software designs from the specifics of the accelerators. To this end, as shown in FIG. 3, O-RAN introduces the concept of AAL Logical Processing Unit (AAL-LPU) 10 as part of the O-RAN AAL 20. An AAL-LPU 10 is a logical representation of the HA 12 resources within a specific NF 14 (e.g., a DU) running in a gNB 16. This representation supports HAs 12 that provide multiple processing units, subsystems, or hard partitions of the HA 12 resources, each represented as an AAL-LPU 10. Although a HA 12 may support multiple AAL-LPUs 10, an AAL-LPU 10 is always associated to a single HA 12, as depicted in FIG. 3. Then, AAL Queues 18 are used by NFs 14 to share AAL-LPU 10 resources. In addition, an AAL-LPU 10 may be associated with one or multiple AAL Profiles, which specify the functions that can be offloaded to a HA 12. This architecture is described in detail in O-RAN Alliance, “O-RAN Acceleration Abstraction Layer General Aspects and Principles (O-RAN.WG6.AAL-GAnP-v01.01)”, Technical Specification, July 2021, which is hereby incorporated by reference herein.

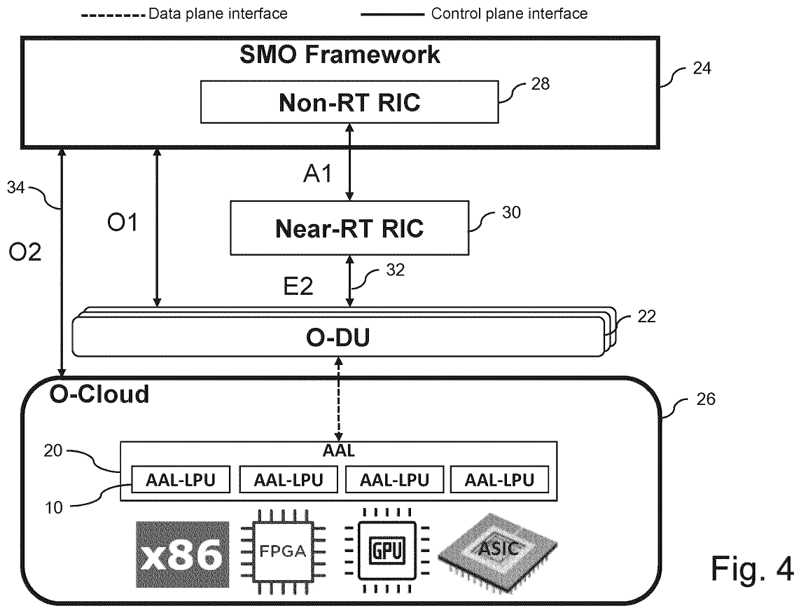

FIG. 4 illustrates a high-level view of the O-RAN architecture, wherein only an O-DU network node 22 is shown for simplicity. As shown, the O-RAN architecture consists of the network functions (e.g. O-DUs 22), a Service Management and Orchestration framework (SMO) 24 to manage the network functions and an O-Cloud 26 (O-RAN Cloud) to host the cloudified network functions. SMO 24 includes the Non-Real-Time (NON-RT) RAN Intelligent Controller (RIC) 28 as a central component, enabling non-real-time control and optimization of RAN elements and resources.

DUs 22 are controlled by the Near-Real-Time (Near-RT) RIC 30 through E2 interface 32. Common 3GPP Radio Resource Management (RRM) operations, for instance, are performed through this interface. Conversely, O2 interface 34 is used to provide two services: infrastructure management services (deployment and management of O-Cloud 26 infrastructure), and deployment management services (lifecycle management of virtualized deployments on O-Cloud 26 infrastructure).

A key problem with this approach is that load balancing cannot be implemented efficiently because NFs 14 can greedily select HAs 12, e.g., in platforms with heterogeneous accelerating resources, NFs 14 may overload the fastest HA 12, which converges to poor performance overall.

In this way, despite providing appropriate abstractions, O-RAN's AAL 20 alone cannot efficiently broker access to shared infrastructure because centralized coordination of acceleration resources (see FIG. 3) is not supported and neither can impose radio scheduling policies to associated DUs 22 (see FIG. 4). Conversely, according to embodiments of the present invention it has been recognized that a centralized control of computing and radio resources is vital to build resource-efficient vRANs.

To address the above issues, embodiments of the present invention provide a higher-layer abstraction implemented on top of O-RAN's AAL 20. According to an embodiment of the invention, this abstraction comprises one or more Virtual Operations (VO) associated with every vRAN node that forwards requests for specific functions. There is one VO per accelerated function, e.g., FEC (Forward Error Correction), FFT (Fast Fourier Transformation), CRC (Cyclic Redundancy Check). The request may include information about the operation and the data that may be required to execute the operation (e.g., code blocks in the case of FEC decoding operation). Furthermore, the request may include settings to execute the operation (e.g., maximum number of decoding iterations in the case of FEC decoding operation).

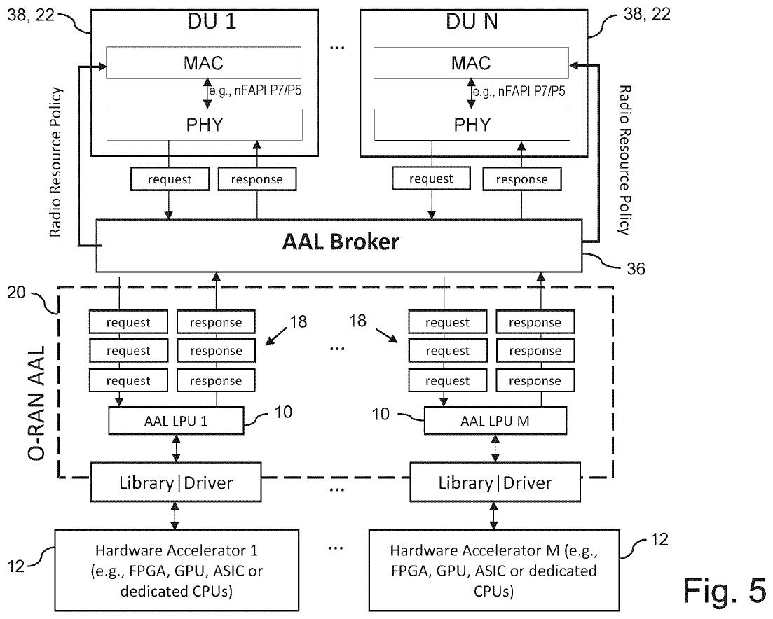

Moreover, according to an embodiment of the invention and as shown in FIG. 5, in which like reference numbers denote like components/functions as in FIGS. 3 and 4, the higher-layer abstraction implemented on top of O-RAN's AAL 20 may comprise an AAL broker 36 that is configured to coordinate all the radio task requests to a pool of Has 12 based on O-Cloud (O-RAN).

More specifically, according to an embodiment, the AAL broker 36 may be configured to receive requests from the vRAN nodes 38 (e.g., a request to LDPC (low-density parity-check)-decode a transport block from a DU 22). Furthermore, the AAL broker 36 may allocate the requests to the processing queue 18 of the most appropriate AAL device 10 according to a scheduling policy. After execution of the requested task by the respective HA 12, the AAL broker 36 may receive the response (i.e. the execution result) from the corresponding AAL device 10 and may forward the response to the issuing vRAN node 38 (e.g., a decoded transport block to a DU 22).

As shown in FIG. 5, according to an embodiment of the invention, the AAL broker 36 may be implemented and configured in such a way that it interacts with O-RAN AAL 20 interface as if it were a single vRAN node 38.

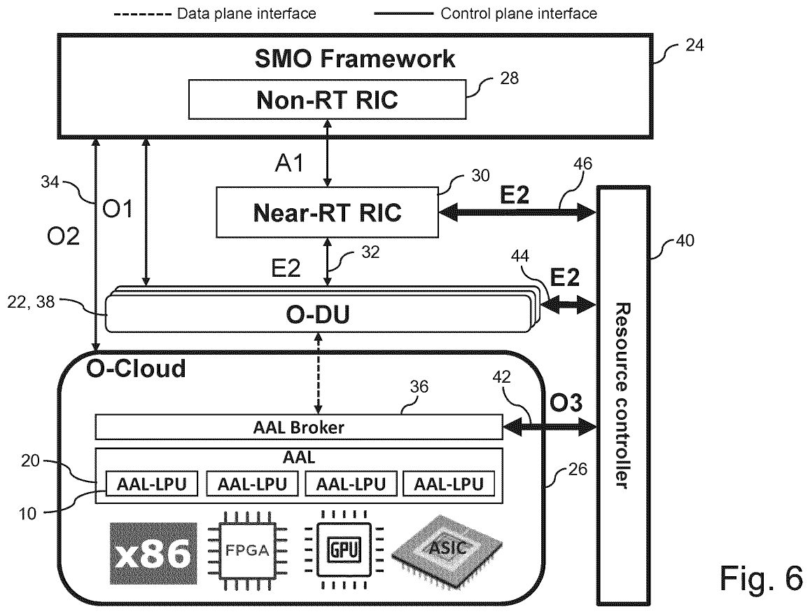

As illustrated in FIG. 6, according to an embodiment of the invention, the system for coordinating allocation of radio processing operations may further comprise a resource controller 40 that may interact/communicate with the AAL broker 36. More specifically, it may be provided that the resource controller 40 configures the AAL broker 36 via a novel O3 interface 42 (near-real-time operation). For instance, via the O3 interface 42, the resource controller 40 may deploy computing policies on the AAL broker 36.

Furthermore, the resource controller 40 may be connected, via a novel E2 interface 44, with vRAN nodes 38, such as O-DUs 22, to configure radio resource policies in these nodes (near-real-time operation). Still further, the resource controller 40 may be connected, via a novel E2 interface 46, with the Near-RT RIC 30. Specifically, interface 46 may be used by the resource controller 40 to notify the Near-RT RIC 3 of changes on radio policies configured on vRAN nodes 38 (e.g. O-DU 22).

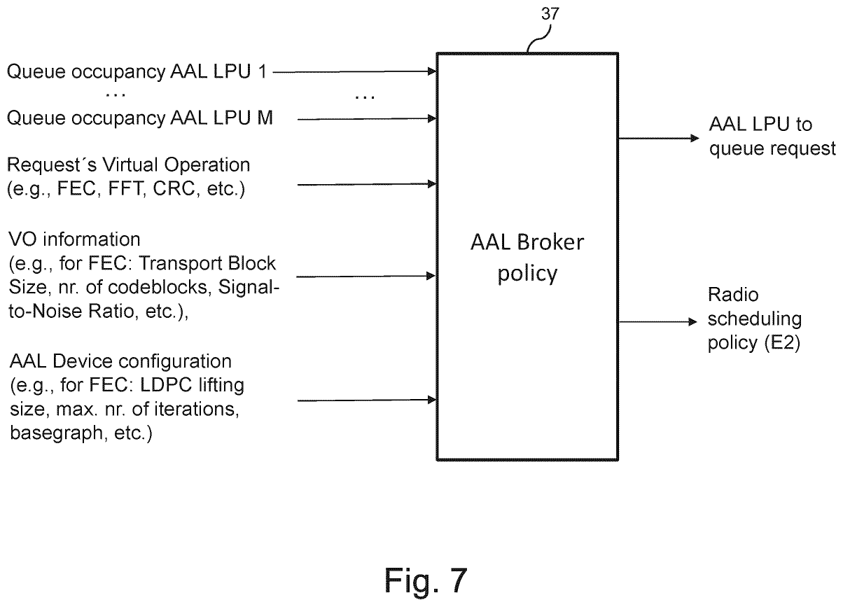

According to an embodiment of the invention, it may be provided that the scheduling policy 37 applied by the AAL broker 36 is implemented with a machine learning (ML) model, an optimization model or an heuristic that maps the system state (in particular the current occupancy of the processing queues 18 at each AAL device 10), the type of request (virtual operation), and information about the incoming request (e.g., transport block size or signal-to-noise ratio) into the AAL LPU 10 that minimizes a cost function. This is schematically illustrated in FIG. 7.

According to an embodiment of the invention, the scheduling policy 37 may be adapted to minimize a cost function that combines information about the networking throughput and energy consumption of the underlying infrastructure, for instance as follows:

$${min}_{{\{ {x}_{t} \}}_{t = 1}^{∞}} {lim}_{T \to ∞} \frac{1}{T} {\sum }_{t = I}^{T} {s}_{t} ( {c}_{t} , {x}_{t} ) + α \cdot {p}_{t} ( {c}_{t} , {x}_{t} ) ,$$

where xₜ is the joint radio/compute scheduling decision made for request t, cₜ is the context associated with request t (e.g., transport block size, SNR, etc.), sₜ(cₜ, xₜ)∈{0,1} denotes whether request t has been served by the accelerator within a pre-defined time constrained (sₜ(cₜ, xₜ)=0) or not (sₜ(cₜ, xₜ)=1), pₜ(cₜ, xₜ) denotes the energy consumed to serve request t given its context cₜ and decision xₜ.

The radio scheduling policies 37 may be imposed on vRAN nodes 38, such as O-DUs 22, by using the novel E2 interface 44 (via the resource controller 40).

It is important to note that the energy that may be required to process a task request is different across accelerators, and so is their latency to serve the request. For instance, the energy consumed by a dedicated CPU to perform LDPC decoding (FEC) is an order of magnitude lower than that of a GPU-based implementation, but its latency is also an order of magnitude larger. This information can be calibrated a priori or learnt via machine learning techniques.
In an embodiment, the present invention provides a method for coordinating allocation of radio processing operations associated with multiple vRAN nodes to shared computing resources, the method comprising using an AAL Broker 36 that coordinates the allocation of common and shared computing resources to radio processing tasks associated with multiple vRAN nodes 38 (e.g., vDUs 22) in a centralized manner.

According to embodiments, the method may comprise one or more of the following steps:
1) A Network Function (NF) requests an operation (e.g. FEC decoding) to the AAL broker 36. The request may include information about the operation and the data that may be required to execute the operation (e.g., code blocks in the case of FEC decoding operation), and settings to execute the operation (e.g., maximum number of decoding iterations in the case of FEC decoding operation).
2) The AAL broker 36 uses a policy to forward the operation request to the queue 18 of a physical hardware accelerator 12 (e.g., a GPU, an FPGA, an ASIC, or a pool of CPUs dedicated to this operation).
3) The hardware accelerator 12 (e.g., a GPU, an FPGA, an ASIC, or a pool of CPUs dedicated to this operation) performs the pre-defined operation for every request in its associated queue 18 in a FIFO manner. Once finished, the response (e.g., decoded bits in the case of a FEC decoding operation) is sent back to the AAL broker 16, which forwards the response to the corresponding vRAN node 38.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method of coordinating allocation of radio processing operations associated with multiple vRAN nodes to shared computing resources, the method comprising:
receiving, by a centralized Acceleration Abstraction Layer (AAL) broker implemented on top of a shared accelerating computing infrastructure, an operation request from a virtual operation associated with a vRAN node, the operation request specifying an operation to be accelerated;
selecting, by the AAL broker using a predefined or configurable scheduling policy, a physical hardware accelerator for accelerated execution of the operation; and
forwarding, by the AAL broker, the operation request to a processing queue of the selected physical hardware accelerator.

2: The method according to claim 1, wherein the AAL broker interacts with the shared accelerating computing infrastructure as an individual vRAN node.

3: The method according to claim 1, wherein the operation request comprises information about the operation that shall be accelerated, the data to execute the operation, and settings to execute the operation.

4: The method according to claim 1, further comprising:
performing, by the selected physical hardware accelerator, the operation in a FIFO manner considering the requests in the processing queue

5: The method according to claim 1, further comprising:
receiving, by the AAL broker, responsive to forwarding the operation request to the processing queue of the selected physical hardware accelerator, a response from the selected physical hardware accelerator; and
forwarding, by the AAL broker, the response received from the selected physical hardware accelerator to the vRAN node.

6: The method according to claim 1, wherein the scheduling policy used by the AAL broker to select the physical hardware accelerator for accelerated execution of the operation is implemented with a machine learning; (ML) model minimizing a cost function that combines information about network throughput and energy consumption of the shared accelerating computing infrastructure.

7: The method according to claim 1, further comprising:
using a resource controller to configure the AAL broker by deploying computing policies via an O3 interface.

8: The method according to claim 1, further comprising:
using a resource controller to configure radio resource policies of vRAN nodes via an E2 interface, and/or to notify changes on radio resource policies configured on vRAN nodes to Near-RT RIC via another E2 interface.

9: A system for coordinating allocation of radio processing operations associated with multiple vRAN nodes to shared computing resources, the system comprising a centralized Acceleration Abstraction Layer (AAL) broker implemented on top of a shared accelerating computing infrastructure, the AAL broker being configured to;
receive an operation request from a virtual operation associated with a vRAN node, the operation request specifying an operation to be accelerated;
select, by using a predefined or configurable scheduling policy, a physical hardware accelerator for accelerated execution of the operation; and
forward the operation request to a processing queue of the selected physical hardware accelerator.

10: The system according to claim 9, wherein the AAL broker is configured to interact with an underlying O-RAN AAL infrastructure.

11: The system according to claim 9, wherein the AAL broker is configured to:
receive, responsive to forwarding the operation request to the processing queue of the selected physical hardware accelerator, a response from the selected physical hardware accelerator; and
forward the response received from the selected physical hardware accelerator to the vRAN node.

12: The system according to claim 9, wherein the AAL broker is further configured to perform the selecting of the physical hardware accelerator for accelerated execution of the operation by means of a machine learning model minimizing a cost function that combines information about network throughput and energy consumption of the shared accelerating computing infrastructure.

13: The system according to claim 9, further comprising a resource controller configured to configure the AAL broker via an O3 interface.

14: The system according to claim 13, wherein the resource controller is further configured to configure radio resource policies of vRAN nodes via an E2 interface.

15: The system according to claim 13, wherein the resource controller is further configured to notify changes on radio resource policies configured on vRAN nodes to Near-RT RIC via an E2 interface.
